(19) United States
(12) Patent Application Publication
(10) Pub. No.: US 2025/0231320 A1
(43) Pub. Date: Jul. 17, 2025

(54) METHOD AND SYSTEM FOR GENERATING AND INVERTING HIGH-RESOLUTION TRUE-COLOR VISIBLE LIGHT MODEL

(71) Applicant: KNOWEATHER (ZHUHAI HENGQIN) METEOROLOGICAL TECHNOLOGY COMPANY LIMITED, Zhuhai (CN)

(72) Inventors: Chuen Chung CHUI, Zhuhai (CN); Ka Ho NG, Zhuhai (CN)

(21) Appl. No.: 19/035,789

(22) Filed: Jan. 23, 2025

Related U.S. Application Data
(63) Continuation of application No. PCT/CN2022/116984, filed on Sep. 5, 2022.

(30) Foreign Application Priority Data
Jul. 29, 2022 (CN) 202210904873.X

(51) Int. Cl. G01W 1/10; G01J 5/48; G01K 11/125; G01W 1/00

(52) U.S. Cl. CPC G01W 1/10; G01J 5/485; G01K 11/125; G01W 2001/006

(57) ABSTRACT

The present disclosure provides a method and system for generating and inferring a high-resolution true-color visible light model. This approach leverages historical infrared brightness temperature data at the original resolution to generate a standard distribution model of historical infrared brightness temperatures. A full-disk two-dimensional brightness temperature model is constructed using historical multi-channel brightness temperature data. This model is then compared with the standard infrared brightness temperature distribution model at the original resolution to assess similarity, allowing for the identification of clear-sky areas and the formation of a corresponding clear-sky mask. The clear-sky signal is subsequently removed to produce a historical multi-channel cloud satellite dataset. To further refine the dataset, the historical multi-channel cloud satellite dataset is regionally segmented, extracting valid data from each region to form a local time-span dataset, ensuring more precise and reliable modeling of true-color visible light reflectance.

### CROSS-REFERENCE TO RELATED APPLICATIONS

This application is a continuation of International Application No. PCT/CN2022/116984, filed on Sep. 5, 2022, which claims priority to Chinese Patent Application No. 202210904873.X, filed on Jul. 29, 2022. All of the aforementioned applications are incorporated herein by reference in their entireties.

### TECHNICAL FIELD

The present disclosure relates to the field of atmospheric remote sensing technology and the field of meteorological monitoring, and in particular to a method and system for generating and inverting a high-resolution true-color visible light model.

### BACKGROUND

Meteorological satellites are important tools for humans to monitor the weather and have existed for over 50 years. Among them, geostationary meteorological satellites, which provide continuous monitoring of specific large areas 24 hours a day, generate images that best meet the needs of weather forecasting operations. The world's currently operational mainstream geostationary meteorological satellites include China's Fengyun-2H and Fengyun-4A, the United States' GOES-16 and GOES-17, Japan's Himawari 8 and 9, and the European Union's Meteosat-8 and Meteosat-11.

Typical meteorological satellites measure the intensity of signals at different wavelengths across the electromagnetic spectrum. The wavelength ranges for these bands are as follows: visible light from 0.4 to 0.7 micrometers, near-infrared light from 0.9 to 7.3 micrometers, and thermal infrared light from 8.7 to 13.4 micrometers. Visible light satellite imagery, also known as daytime meteorological satellite imagery, is generated based on the reflectance observed in the solar visible spectrum and can be presented in either true-color or black-and-white formats. Due to its spatial and temporal continuity, visible satellite imagery allows meteorologists to clearly observe the shape, type, arrangement, and movement of cloud formations. This facilitates the monitoring of various weather systems and phenomena, such as fronts, typhoons, extratropical cyclones, Northeast cold vortices, severe convection, fog, sandstorms, and air pollution, as well as their development and dynamics. On the other hand, infrared satellite imagery includes images captured in both the near-infrared and thermal infrared bands. Professional meteorologists can use this imagery to determine cloud height and type, calculate meteorological and oceanographic parameters such as land and sea surface temperatures, and detect the concentrations of gases such as water vapor and ozone.

Due to the significantly higher intensity of visible light originating from the Earth's surface under solar illumination compared to infrared light, the spatial resolution of visible light band reflectance is generally higher than that of infrared band brightness temperature data, with the former reaching up to 500 meters. Furthermore, visible light signals directly reflect the appearance of clouds under sunlight, allowing meteorologists to clearly and precisely distinguish and track the locations of clouds, fog, and pollutants at different altitudes.

During the implementation of the present disclosure, the inventors found that the prior art has at least the following issues:

Visible light originates from the sun; therefore, the reflectance and contrast of true-color visible light bands are affected by the angle of sunlight and cannot be captured at night. For regions in darkness, forecasters can only use infrared satellite imagery, relying on the generally reasonable assumption that “colder means higher” to judge the location of clouds based on low brightness temperatures. Although infrared satellite imagery can be captured for 24 hours a day and its brightness and contrast are not affected by the angle of sunlight, when the ground cools down at night and inversion occurs, the surface temperature can be similar to that of low clouds/fog, making it difficult for meteorologists to determine the location of low clouds. Currently, the meteorological industry also generates false-color infrared satellite images by fusing multiple infrared channel data to determine cloud types based on color. However, this false-color infrared satellite data cannot reflect the true colors of the signals, making it impossible for forecasters to distinguish non-water vapor airborne particles (such as pollutants and sandstorms), thus accurate monitoring is challenging, and operational capabilities are somewhat limited.

Existing known technologies include special high-sensitivity instruments mounted on polar-orbiting satellites that generate nighttime visible light satellite imagery by detecting the intensity of visible light reflected from the Earth's surface by the moon. However, compared to the wide-range 24-hour monitoring provided by geosynchronous satellites, polar-orbiting satellites can only observe very limited areas about twice a day, and the visible light from the moon is affected by lunar phases, making this nighttime visible light satellite reflectance retrieval technology extremely unreliable and unable to meet the operational needs of meteorological forecasters.

### SUMMARY

The objective of the present disclosure is to provide a method and system for generating and inverting a high-resolution true-color visible light model, which can overcome the technical problems described in the background and quickly and reliably convert and generate day/night true-color visible light satellite imagery.

The embodiments of the present disclosure are implemented as follows:

A method for generating a high-resolution true-color visible light model, wherein the generation method comprises the following steps:
projecting historical infrared signal intensity data of original resolution onto a geographical coordinate system, preprocessing a brightness temperature data in the historical infrared data, and generating a standard distribution model of historical infrared brightness temperature at the original resolution;
collecting a multi-channel satellite observation dataset, preprocessing the multi-channel satellite observation data to form a full-disk two-dimensional brightness temperature model; comparing the similarity between the full-disk two-dimensional brightness temperature model and the standard distribution model of infrared brightness temperature at the original resolution, identifying a clear-sky area, and forming a clear-sky mask within the clear-sky area; and removing a clear-sky signal to generate a historical multi-channel cloud satellite dataset; and
segmenting the historical multi-channel cloud satellite dataset into regions and extracting valid data from each region to construct a local time-span dataset; dividing the two-dimensional brightness temperature data in the local time-span dataset for each region into a training set, a validation set, and a test set; performing distributed training using geographical data; and integrating the results after training to obtain a true-color visible light band reflectance model at the original resolution.

In a preferred embodiment of the present disclosure, the aforementioned historical infrared data at the original resolution includes full-disk range data observed by any geosynchronous satellite.

In a preferred embodiment of the present disclosure, generating the standard distribution model of historical infrared brightness temperature at the original resolution comprises the following steps:
extracting the brightness temperature data from the infrared channel in the historical infrared data;
sorting the brightness temperature data collected at the same solar time by brightness temperature value in ascending order;
selecting a clear-sky brightness temperature data based on the sorting results; and
constituting a two-dimensional brightness temperature data matrix based on the clear-sky brightness temperature data to generate the standard distribution model of infrared brightness temperature at the original resolution.

In a preferred embodiment of the present disclosure, preprocessing the multi-channel satellite observation data to form the full-disk two-dimensional brightness temperature model comprises the following steps:
projecting the obtained multi-channel satellite observation data onto a geographical coordinate system;
constructing a two-dimensional data matrix for each channel of satellite observation data; and
extracting the full-disk two-dimensional brightness temperature model from the two-dimensional data matrix, which corresponds to the infrared band of the standard distribution model of historical infrared brightness temperature.

In a preferred embodiment of the present disclosure, comparing the similarity between the full-disk two-dimensional brightness temperature model and the standard distribution model of infrared brightness temperature at the original resolution, identifying the clear-sky area, and forming the clear-sky mask within the clear-sky area comprises the following steps:
using a sliding window with an N*N pixel area, and continuously calculating the SSIM value locally while sliding, where the N*N pixel area represents a pixel grid with a length of N and a width of N, and its pixel area size is N*N, with N being a real integer; and
classifying an area as a clear-sky area if the SSIM value is greater than 0.85.

In a preferred embodiment of the present disclosure, removing the clear-sky signal to generate the historical multi-channel cloud satellite dataset comprises:
replacing the reflectance values of historical true-color visible light satellite data within the clear-sky mask with an average reflectance of the corresponding clear sky value (gridded surface type);
replacing the brightness temperature values of infrared channel data within the clear-sky mask with a specific value; and
reorganizing the data for each channel and outputting the data for each channel as the historical multi-channel cloud satellite dataset.

In a preferred embodiment of the present disclosure, the method for obtaining valid data in the local time-span dataset comprises:
extracting the historical multi-channel cloud satellite dataset from three hours before and after standard (local solar) noon time, and dividing the dataset into four equal parts to form the local time-span dataset.

In a preferred embodiment of the present disclosure, the specific operation method for the local time-span dataset comprises:
converting the infrared channel data into 8-bit metadata corresponding to brightness temperature values from 180 K to 320 K, ranging from 0 to 255, and using the 8-bit metadata as a red channel of a pseudo-color image;
converting infrared channel brightness temperature data into 8-bit metadata corresponding to brightness temperature values from 180 K to 320 K, ranging from 0 to 255, and using the 8-bit metadata as a green channel of the pseudo-color image;
converting global altitude data into 8-bit metadata corresponding to altitudes from −10 meters to 4000 meters, ranging from 0 to 255, and using the 8-bit metadata as a blue channel of the pseudo-color image;
merging and overlaying the red channel, the green channel and the blue channel to generate the pseudo-color image; and
converting multi-channel visible light reflectance data into 8-bit metadata for each respective channel, and merging the 8-bit metadata according to color attributes to form a true-color visible light image.

In a preferred embodiment of the present disclosure, the distributed training comprises the following steps:
transmitting the training set, the validation set, and the test set to distributed training nodes using a SSH protocol; and
each node performing training and modeling using an adversarial neural network pix2pixHD to generate the true-color visible light band reflectance model.

A method for inferring a high-resolution true-color visible light model, comprising a high-resolution true-color visible light method, wherein the method comprises:
inferring the true-color visible light band reflectance model to obtain a local area true-color visible light reflectance tile matrix at the original resolution;
replacing pixel values within the clear-sky area with color values corresponding to the surface reflectance in the corresponding area to generate a local area true-color visible light reflectance tile; and
merging the local area true-color visible light reflectance tiles according to geographical regions to form a true-color visible light cloud image, with a spatial resolution of no less than 4 kilometers.

In a preferred embodiment of the present disclosure, for overlapping parts of the local area during the merging process, applying smoothing processing.

A system for generating and inferring high-resolution true-color visible light intensity, wherein the system for generating and inferring the high-resolution true-color visible light intensity comprises:
a data acquisition device, configured to obtain satellite data at the original resolution, including but not limited to historical infrared data, multi-channel satellite observation data, and geographical coordinate data.
a data preprocessing device, configured to extract historical infrared data and brightness temperature data from multi-channel satellite observation data, and to form a standard distribution model of historical infrared brightness temperature and a full-disk two-dimensional brightness temperature model, respectively;
a clear-sky mask processing device, configured to compare the similarity between the standard distribution model of historical infrared brightness temperature and the full-disk two-dimensional brightness temperature model for the same time period and region, identify a clear-sky area, and form a clear-sky mask within the clear-sky area; and after removing a clear-sky signal, generate a historical multi-channel cloud satellite dataset;
a data learning device, configured to perform distributed training on the historical multi-channel cloud satellite dataset at each node and form a true-color visible light band reflectance model at the original resolution; and a data inference device, configured to infer the true-color visible light band reflectance model to obtain a local true-color visible light reflectance tile matrix; and merge the local true-color visible light reflectance tile matrix according to geographical regions to form a true-color visible light cloud image, and apply smoothing processing to overlapping areas.

The benefits of the embodiments of the present disclosure are as follows: The high-resolution true-color visible light method in the present disclosure obtains the ground infrared signal brightness temperature distribution under clear sky conditions within the same observation area and time period by acquiring historical infrared data. It then performs texture comparison between this distribution and the infrared brightness temperature distribution from historical multi-channel satellite observation data within the same region and period, identifying clear sky signals within the same region and period and generating a clear sky mask. Subsequently, the ground infrared channel signals within the region are removed to prevent misinterpretation of low brightness temperature signals from the ground as cloudy areas during cloud-free nights when using machine learning or deep learning models, resulting in the retrieval of false cloud visible light reflectance, thereby effectively suppressing the issue of false cloud appearance under clear sky conditions. During the automated data learning phase, distributed learning is employed to effectively reduce the complexity, training time, and runtime of individual models, enhancing accuracy and operational efficiency. This enables the retrieval of visible light band reflectance across global regions, all while maintaining high resolution, resulting in a true-color visible light band reflectance model that can infer true-color visible light cloud images, achieving high-frequency, rapid, stable, reliable, high-definition, and real-time visible light band reflectance retrieval for all times globally.

### BRIEF DESCRIPTION OF THE DRAWINGS

To more clearly illustrate the technical solution of the embodiments of the present disclosure, the figures used in the embodiments will be briefly introduced below. It should be understood that the following figures only show certain embodiments of the present disclosure and should not be regarded as limiting the scope. For a person of ordinary skill in the art, other related figures can be derived from these figures without exerting creative effort.

FIG. 1 is a flowchart of the model training process for the high-resolution true-color visible light model in an embodiment of the present disclosure;

FIG. 2 is a conceptual diagram of the full-disk coverage of a geosynchronous satellite in an embodiment of the present disclosure;

FIG. 3 is an example (local area tile) of a clear-sky infrared brightness temperature standard distribution model generated in an embodiment of the present disclosure;

FIG. 4 is a schematic diagram of the overlapping region decomposition method and solar time interval classification in an embodiment of the present disclosure;

FIG. 5 is an effect image converted from nighttime B13 infrared channel brightness temperature data of a local area in an embodiment of the present disclosure;

FIG. 6 is a flowchart of the system data processing in an embodiment of the present disclosure.

### DETAILED DESCRIPTION OF THE EMBODIMENTS

To make the objectives, technical solutions, and advantages of the embodiments of the present disclosure clearer, the technical solutions of the embodiments of the present disclosure will be described clearly and completely below with reference to the accompanying drawings. It is evident that the described embodiments are a part of the embodiments of the present disclosure, rather than all of them. Therefore, the detailed description of the embodiments of the present disclosure provided in the accompanying drawings is not intended to limit the scope of the present disclosure as claimed, but merely represents selected embodiments of the present disclosure. Based on the embodiments of the present disclosure, all other embodiments obtained by a person of ordinary skill in the art without inventive effort fall within the scope of protection of the present disclosure.

Although technologies exist for training deep learning models to infer visible light satellite imagery from historical infrared data, these techniques are limited to converting infrared satellite data into black-and-white visible light imagery. Additionally, when the inventors of the present disclosure attempted to replicate the related technology, they found that the deep learning model erroneously interpreted infrared signals associated with significant nighttime cooling in clear-sky areas as cloud signals. This misinterpretation led to the appearance of clouds in clear-sky regions, severely impacting meteorologists' analyses and the performance of other algorithms. To address this issue, the present embodiment provides a method and system for generating and retrieving a true-color visible light model with enhanced reliability, higher resolution, and greater processing speed.

### First Embodiment

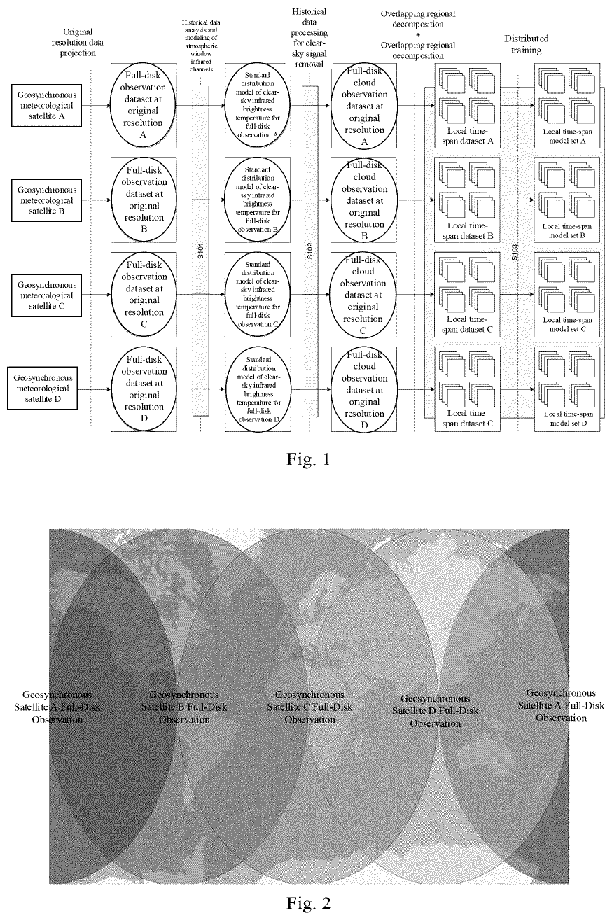

Referring to FIG. 1, a method for generating a high-resolution true-color visible light model, wherein the generation method comprises the following steps:

S101: Projecting a historical infrared data of original resolution onto a geographical coordinate system, preprocessing a brightness temperature data in the historical infrared data, and generating a standard distribution model of historical infrared brightness temperature at the original resolution.

In this embodiment, the historical infrared data at its original resolution is obtained from meteorological satellites, which can be any geosynchronous satellites, including but not limited to those with any infrared channels. In the embodiment of the present disclosure, it is assumed that there are four meteorological satellites, namely Geosynchronous Satellites C, D, A, and B, positioned at 0° E, 90° E, 180° W, and 90° W above the equator, respectively, all of which have been operational since June 2015 and share the same technical specifications and observation frequencies as Japan's Himawari-8/9 geosynchronous satellites. Their specific full-disk coverage can be referred to in FIG. 2. The B13 infrared channel of Japan's Himawari-8/9 geosynchronous satellite (hereinafter referred to as B13) is used to create a standard distribution model of clear-sky infrared brightness temperatures.

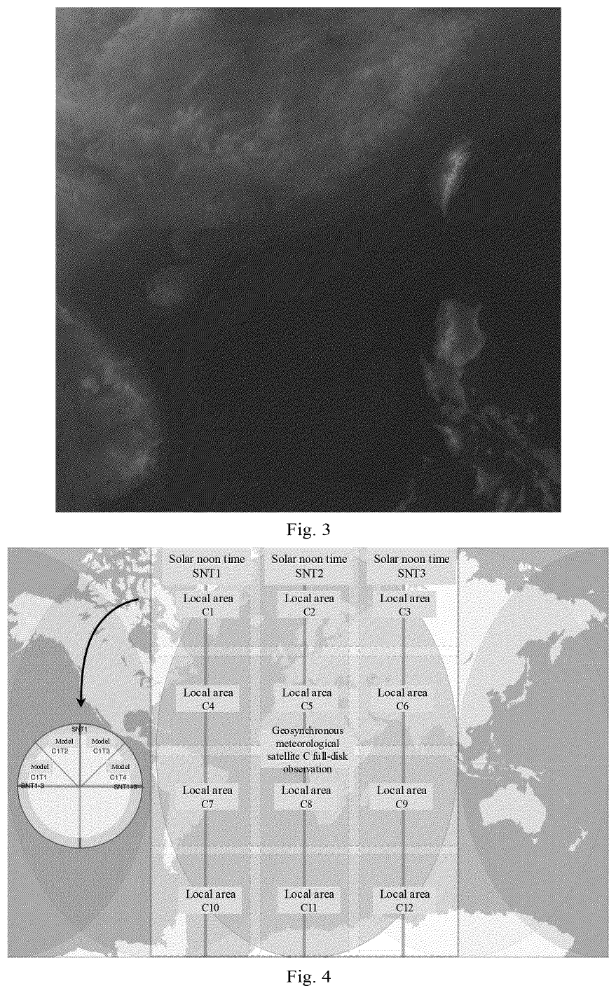

The specific procedure is as follows: Using conventional geometric formulas, the historical full-disk B13 data from Satellites A, B, C, and D is projected onto a Mercator projection coordinate system at its original highest resolution (2 km). Subsequently, the historical data from Satellites A, B, C, and D is categorized by month, and for each grid point within the full-disk observation range of each month, the historical B13 brightness temperature values are ranked. The 5th percentile brightness temperature is then taken as the clear-sky brightness temperature, forming a two-dimensional brightness temperature data matrix for the full-disk observation range of Satellites A, B, C, and D. This serves as the standard distribution model of clear-sky infrared brightness temperatures at the original resolution for different months for each satellite (see FIG. 3 for reference).

Although existing technologies incorporate numerical forecast surface temperatures as one dimension, the current global forecast model has a resolution of only 9 km, which is far lower than the observational precision of meteorological satellites. As a result, the generated nighttime visible light satellite images exhibit prominent large-grid textures, which not only compromise visual clarity but also hinder meteorologists and automated algorithms from accurately identifying cloud types.

S102: Collecting a multi-channel satellite observation data, preprocessing the multi-channel satellite observation data to form a full-disk two-dimensional brightness temperature model; comparing the similarity between the full-disk two-dimensional brightness temperature model and the standard distribution model of infrared brightness temperature at the original resolution, identifying a clear-sky area, and forming a clear-sky mask within the clear-sky area; and removing a clear-sky signal to generate a historical multi-channel cloud satellite dataset.

This step involves performing a statistical analysis of historical brightness temperature data from the infrared atmospheric window band to determine the distribution of ground infrared signal brightness temperatures under clear-sky conditions for different seasons in the observation area. By comparing the texture of this distribution with the brightness temperature distribution of the same infrared channel from individual historical observations, clear-sky areas for each observation can be identified. Subsequently, infrared channel signals within these regions are excluded to construct a cloud satellite observation dataset. This approach effectively prevents machine learning and deep learning models from misinterpreting low brightness temperature signals from the ground on clear nights as cloud formations, thereby avoiding the generation of false cloud visible light reflectance and mitigating the issue of false cloud appearances under clear-sky conditions.

The specific operation is as follows: Extract full-disk B13 brightness temperature data for all observation times from Satellites A, B, C, and D between 2016 and 2021. Using conventional geometric formulas, project the base data onto a Mercator projection coordinate system at its original highest resolution. Convert both the full-disk two-dimensional brightness temperature model for each observation time and the standard distribution model of clear-sky infrared brightness temperatures into 8-bit data (with brightness temperature values ranging from 180 K to 320 K corresponding to 0-255). Create two grayscale images. Then, use a 7×7 pixel sliding window to locally calculate the structural similarity index (SSIM) between the B13 brightness temperature distribution image from all historical observation times of Satellites A, B, C, and D and the corresponding monthly standard distribution model image of clear-sky infrared brightness temperatures. The SSIM is defined as:

$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )} ,$$

where x is the color value of the B13 brightness temperature distribution image, y is the color value of the standard distribution model image of clear-sky infrared brightness temperatures based on B13, μₓ is the average of x, μ_{y} is the average of y; σₓ² is the variance of x, σ_{y}² is the variance of y; σ_{xy} is the covariance between x and y; c₁=(k₁L)², c₂=(k₂L)², where L=255, k1=0.01, k2=0.03.

In principle, when the SSIM value between the two is above 0.85, the area within the sliding window can be classified as a clear-sky area. In this embodiment, an SSIM value greater than 0.95 is used to determine a clear-sky area. The sliding window is then continuously moved to gradually construct a full-disk clear-sky mask for that observation time, and the brightness temperature values within the clear-sky mask in the original B13 two-dimensional data matrix are replaced with 400 K. Additionally, extract B01, B02, and B03 channels from Satellites A, B, C, and D between 2016 and 2021 as historical true-color visible light satellite data, where B01 is the blue channel, B02 is the green channel, B03 is the red channel, and B12 is another infrared channel data. Using conventional geometric formulas, project the historical base data of B01, B02, B03, and B12 onto a Mercator projection coordinate system at their original highest resolution, and create two-dimensional data matrices for all observation times of B01, B02, B03, and B12.

Subsequently, based on the location of the clear-sky mask for each observation time, replace the reflectance values of B01, B02, and B03 within the clear-sky mask with the average reflectance of the corresponding surface type, and replace the brightness temperature values of B12 with 400 K. The B01, B02, B03, B12, and B13 data processed for clear-sky signals constitute the historical full-disk satellite cloud observation dataset.

S103: Segmenting the historical multi-channel cloud satellite dataset into regions and extracting valid data from each region to construct a local time-span dataset; dividing the two-dimensional brightness temperature data in the local time-span dataset for each region into a training set, a validation set, and a test set; performing distributed training using geographical data; and integrating the results after training to obtain a true-color visible light band reflectance model at the original resolution.

In prior art, using a single model to convert and generate high-resolution images on a global scale for a single localized region often leads to high model complexity, which can adversely affect model performance. Additionally, limited memory and computing power make it difficult to generate high-resolution images in a short period. To address these issues, this step introduces a distributed learning approach.

This step employs a trained set of distributed machine learning or deep learning models to rapidly convert infrared channel observation data from various geosynchronous satellites into global daytime true-color visible light band reflectance. By overlapping regional decomposition of the full-disk monitoring range of each geosynchronous satellite based on solar time, this step achieves automated historical data selection and distributed machine learning and deep learning, effectively reducing the complexity, training time, and runtime of individual models, while improving accuracy and operational efficiency. It enables the retrieval of visible light reflectance on a global scale without sacrificing resolution.

The specific embodiment is as follows: For the observable full-disk region of each geosynchronous meteorological satellite, historical original-resolution satellite data and true-color visible light reflectance within a specified time span before and after local solar noon are divided into several sets of solar time regional datasets based on specific time intervals and geographical ranges. Subsequently, each set of solar time regional datasets, combined with geographic information data within each geographical range, is allocated to a designated training node in a training set. Machine learning or deep learning algorithms are then used to train each set of regional datasets independently, yielding several models that can convert local infrared satellite observation data and geographic information data into local original-resolution true-color visible light reflectance.

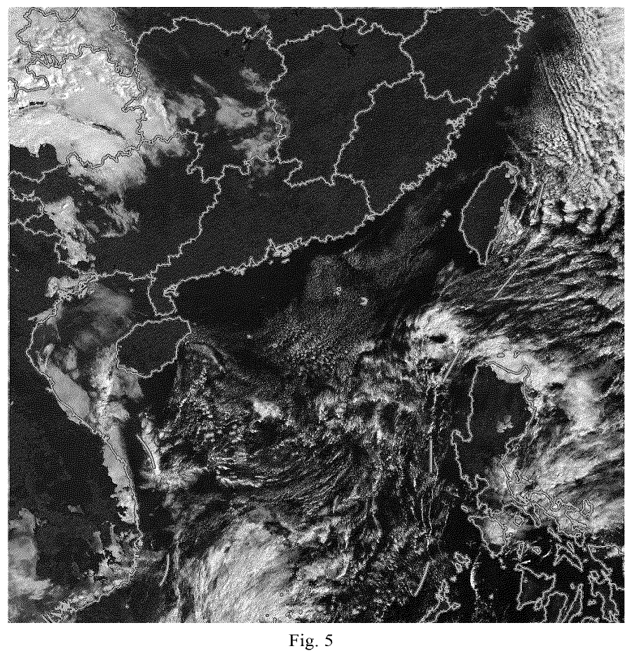

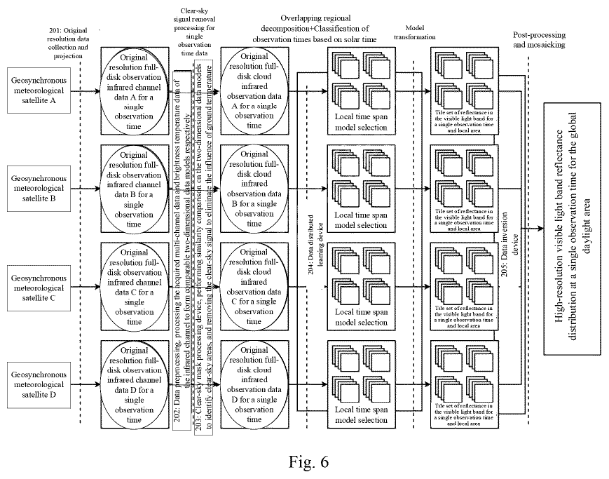

In the embodiments of the present disclosure, the full-disk coverage areas of satellites A, B, C, and D are decomposed into 12 local regions using an overlapping regional decomposition method. For specific reference, see FIG. 4 for the regional decomposition of Satellite C; the regional decomposition methods for Satellites A, B, and D are roughly the same as that of Satellite C. Taking Satellite C as an example, C1, C4, C7, and C10 have the same longitude, so their solar noon time (standard noon time) is SNT1; C2, C5, C8, and C11 have the same longitude, so their solar noon time (standard noon time) is SNT2; C3, C6, C9, and C12 have the same longitude, so their solar noon time (standard noon time) is SNT3.

Thereafter, to avoid model performance being affected by nighttime dark areas, only historical full-disk satellite cloud observation data from 3 hours before and after the standard noon time for each local region is obtained as the dataset for each local area. Each local region dataset is then averaged and divided into 4 solar time local datasets based on time.

Subsequently, solar time local image sets are created using the following method: Convert B12 and B13 data into 8-bit data (0-255 corresponding to brightness temperature values of 180K to 320K), which serve as the red and green channel values of a pseudo-color image, respectively; convert global altitude data into 8-bit data (0-255 corresponding to −10 meters to 4000 meters), which serves as the blue channel of the pseudo-color image. Finally, the three channels are merged and superimposed to generate a pseudo-color image. At the same time, B01, B02, and B03 visible light reflectance data are converted into three 8-bit values (corresponding to reflectance thresholds of 0 to 1) and combined according to their color attributes to form a true-color visible light image. This embodiment strictly follows the requirements of the “Patent Examination Guidelines,” and the applicant may submit color effect images generated during the image data processing as supplementary materials to facilitate understanding.

Lastly, images from 2016 to 2020 in each solar time local image set are designated as the training set, images from 2021 as the validation set, and images from 2022 as the test set. The data is transmitted to a total of 48 training nodes via SSH and trained using the pix2pixHD adversarial neural network model to yield 48 models that can convert pseudo-color images, synthesized from B13, B12, and altitude, into true-color visible light satellite images based on solar time. Since the regional decomposition method, solar time classification, data processing, allocation, and model training for Satellites A, B, and D are the same as those for Satellite C, a total of 192 pix2pixHD conversion models are trained. Subsequently, the red, green, and blue channel color values of the images are converted into reflectance values for the red, green, and blue channels, with a linear correspondence of 0-255 to 0-1 reflectance values, thereby obtaining models for local original-resolution true-color visible light reflectance (please refer to FIG. 5).

This embodiment also provides a high-resolution true-color visible light conversion method, which can obtain a true-color visible light cloud image through a true-color visible light band reflectance inference model. The conversion method is as follows:

Obtain a local area true-color visible light reflectance tile matrix at the original resolution through the true-color visible light band reflectance model; replace the pixel values within the clear-sky area with the color values corresponding to the land surface reflectance of the corresponding area to generate local area true-color visible light reflectance tiles; and merge the local area true-color visible light reflectance tiles according to geographical regions to form a true-color visible light cloud image with a spatial resolution of no less than 4 kilometers. For overlapping parts of the local area during the merging process, applying smoothing processing.

A system for generating and inferring high-resolution true-color visible light intensity, wherein the system for generating and inferring the high-resolution true-color visible light intensity comprises:
201 a data acquisition device, configured to obtain Earth-synchronous meteorological satellite data at the original resolution. The Earth-synchronous meteorological satellite data includes, but is not limited to, historical infrared channel data, multi-channel satellite observation data, and geographical coordinate data;
202 a data preprocessing device, configured to extract historical infrared channel data and brightness temperature data from multi-channel satellite observation data, and to preprocess these data to form a standard distribution model of historical infrared light brightness temperature and a full-disk two-dimensional brightness temperature model, respectively;
203 a clear-sky mask processing device, configured to compare the similarity between the standard distribution model of historical infrared brightness temperature and the full-disk two-dimensional brightness temperature model for the same time period and region, identify a clear-sky area, and form a clear-sky mask within the clear-sky area; and after removing a clear-sky signal, generate a historical multi-channel cloud satellite dataset;
204 a data learning device, configured to replace the values of the infrared channel observation data located within the clear-sky mask range during a single observation time with specific values, and output them as original resolution two-dimensional data matrices for each channel; and to perform distributed training on the historical multi-channel cloud satellite dataset at each node and form a true-color visible light band reflectance model at the original resolution;
the data learning device is used to decompose, using the region decomposition method employed during model array establishment, each infrared channel's original resolution two-dimensional brightness temperature data matrix outputted by the preprocessing device for full-disk infrared channel observation data at a single time point. The data learning device then transmits the infrared channel data required for the corresponding geographical domain range, based on the observation time, to the host equipped with the corresponding regional transformation model, where the infrared channel data is converted into a regional original resolution single-time preliminary true-color visible light band reflectance; and
205 a data inference device, configured to infer the true-color visible light band reflectance model to obtain a local true-color visible light reflectance tile matrix; and merge the local true-color visible light reflectance tile matrix according to geographical regions to form a true-color visible light cloud image, and apply smoothing processing to overlapping areas.

The specific operation of the data inference device is as follows:

The post-processing device for high-resolution visible light band reflectance at a single observation time for the global daylight area is used to replace the pixel values within the cloud-free regions, as calculated by the clear-sky mask generation device for the corresponding single observation time, with the corresponding color values of the reflectance for the respective landforms in the original resolution local area true-color visible light satellite reflectance tile matrix generated by the visible light band reflectance inversion device for a single time point. This process produces the final single observation time original resolution regional true-color visible light band reflectance tiles. Finally, based on the geographical division of the region decomposition method, all the regional true-color visible light band reflectance tiles are merged into a single observation time global daytime true-color visible light band reflectance with a spatial resolution of no less than 4 kilometers, and smoothing processing is applied to the overlapping parts between local regions.

The benefits of the embodiments of the present disclosure are as follows:
(1) By adopting the method of clear-sky masking, the issue of erroneously high reflectance (false clouds) in clear-sky regions can be effectively suppressed, allowing the acquisition of nighttime true-color visible light cloud images without relying on lunar phase or numerical weather prediction data.
(2) Utilizing a distributed parallel machine learning or deep learning model ensemble can effectively reduce the complexity, training time, and runtime of individual models, enhancing accuracy and operational efficiency. This approach can be deployed globally without sacrificing resolution, enabling high-frequency, rapid, reliable, high-definition, and single-observation-time global daytime visible light band reflectance retrieval. It achieves large-scale, high-frequency, reliable, and real-time visible light satellite reflectance retrieval.
(3) By processing data at its original resolution, a single-observation-time global true-color visible light band reflectance model with a spatial resolution of no less than 4 kilometers is obtained, allowing for the retrieval of full-time global true-color visible light cloud images.

The high-resolution true-color visible light method in the present disclosure obtains the ground infrared signal brightness temperature distribution under clear sky conditions within the observation area across different time periods by acquiring historical infrared data. It then performs texture comparison between this distribution and the infrared brightness temperature distribution from historical multi-channel satellite observation data within the same region and period, identifies clear sky signals within the same region and period, and generates a mask. Subsequently, the ground infrared channel signals within the region are removed to prevent misinterpretation of low brightness temperature signals from the ground as cloudy areas during cloud-free nights when using machine learning or deep learning models, which could otherwise result in the retrieval of false cloud visible light reflectance, thereby effectively suppressing the issue of false cloud appearance under clear sky conditions. During the automated data learning phase, distributed learning is employed to effectively reduce the complexity, training time, and runtime of individual models, enhancing accuracy and operational efficiency. This enables the retrieval of visible light band reflectance across global regions, all while maintaining high resolution, resulting in a true-color visible light band reflectance model that can infer true-color visible light cloud images, achieving high-frequency, rapid, stable, reliable, high-definition, and real-time visible light band reflectance retrieval for all times globally.

The specification describes examples of embodiments of the present disclosure and does not imply that these embodiments illustrate and describe all possible forms of the present disclosure. It should be understood that the embodiments in the specification can be implemented in various alternative forms. The drawings are not necessarily drawn to scale; some features may be enlarged or reduced to show details of specific components. The specific structural and functional details disclosed should not be construed as limiting but rather as providing a representative basis for teaching those skilled in the art to implement the present disclosure in various forms. Those skilled in the art should understand that multiple features described with reference to any one drawing may be combined with features illustrated in one or more other drawings to form embodiments that are not explicitly illustrated or described. The combined features described provide representative embodiments for typical applications. However, various combinations and variations of features consistent with the teachings of the present disclosure may be used for specific applications or implementations as needed.

The above description is merely a preferred embodiment of the present disclosure and is not intended to limit the present disclosure. For those skilled in the art, the present disclosure may be subject to various modifications and changes. Any modifications, equivalent substitutions, improvements, etc., made within the spirit and principles of the present disclosure, should be included within the scope of protection of the present disclosure.

What is claimed is:

1. A method for generating a high-resolution true-color visible light model, wherein the generation method comprises the following steps:
projecting a historical infrared data at original resolution onto a geographical coordinate system, preprocessing a brightness temperature data in the historical infrared data, and generating a standard distribution model of historical infrared brightness temperature at the original resolution;
collecting a multi-channel satellite observation dataset, preprocessing the multi-channel satellite observation data to form a full-disk two-dimensional brightness temperature model; comparing the similarity between the full-disk two-dimensional brightness temperature model and the standard distribution model of historical infrared brightness temperature at the original resolution, identifying a clear-sky area, and forming a clear-sky mask within the clear-sky area; and removing a clear-sky signal to generate a historical multi-channel cloud satellite dataset; and
segmenting the historical multi-channel cloud satellite dataset into regions and extracting valid data from each region to construct a local time-span dataset; dividing the two-dimensional brightness temperature data in the local time-span dataset for each region into a training set, a validation set, and a test set; performing distributed training using geographical data; and integrating the results after training to obtain a true-color visible light band reflectance model at the original resolution.

2. The method for generating the high-resolution true-color visible light model according to claim 1, wherein generating the standard distribution model of historical infrared brightness temperature at the original resolution comprises the following steps:
projecting infrared channel data obtained from a plurality of geosynchronous satellites onto the geographical coordinate system at a resolution equivalent to 2 kilometers;
extracting the brightness temperature data from the infrared channel in the historical infrared data for the same region and period;
sorting the brightness temperature data by brightness temperature value;
selecting a clear-sky brightness temperature data based on the sorting results; and
constituting a two-dimensional brightness temperature data matrix based on the clear-sky brightness temperature data to generate the standard distribution model of historical infrared brightness temperature at the original resolution.

3. The method for generating the high-resolution true-color visible light model according to claim 1, wherein preprocessing the multi-channel satellite observation data to form the full-disk two-dimensional brightness temperature model comprises the following steps:
projecting the obtained multi-channel satellite observation data onto the geographical coordinate system;
constructing a two-dimensional data matrix for each channel of satellite observation data; and
extracting the full-disk two-dimensional brightness temperature model from the two-dimensional data matrix, which corresponds to the infrared band of the standard distribution model of historical infrared brightness temperature at the original resolution.

4. The method for generating the high-resolution true-color visible light model according to claim 1, wherein comparing the similarity between the full-disk two-dimensional brightness temperature model and the standard distribution model of historical infrared brightness temperature at the original resolution, identifying the clear-sky area, and forming the clear-sky mask within the clear-sky area comprises the following steps:
using a sliding window with an N*N pixel area, and continuously calculating the SSIM value locally while sliding; and
classifying an area as a clear-sky area if the SSIM value is greater than 0.85.

5. The method for generating the high-resolution true-color visible light model according to claim 1, wherein removing the clear-sky signal to generate the historical multi-channel cloud satellite dataset comprises:
replacing the reflectance values of historical true-color visible light satellite data within the clear-sky mask with an average reflectance of the corresponding clear sky value (gridded surface type);
replacing the brightness temperature values of infrared channel data within the clear-sky mask with a specific value; and
reorganizing the data for each channel and outputting the data for each channel as the historical multi-channel cloud satellite dataset.

6. The method for generating the high-resolution true-color visible light model according to claim 1, wherein the method for obtaining valid data in the local time-span dataset comprises: extracting the historical multi-channel cloud satellite dataset from three hours before and after standard (local solar) noon time, and dividing the dataset into four equal parts to form the local time-span dataset.

7. The method for generating the high-resolution true-color visible light model according to claim 1, wherein the specific operation method for the local time-span dataset comprises:
converting the infrared channel data into 8-bit metadata corresponding to brightness temperature values from 180 K to 320 K, ranging from 0 to 255, and using the 8-bit metadata as a red channel of a pseudo-color image;
converting infrared channel brightness temperature data into 8-bit metadata corresponding to brightness temperature values from 180 K to 320 K, ranging from 0 to 255, and using the 8-bit metadata as a green channel of the pseudo-color image;
converting global altitude data into 8-bit metadata corresponding to altitudes from −10 meters to 4000 meters, ranging from 0 to 255, and using the 8-bit metadata as a blue channel of the pseudo-color image;
merging and overlaying the red channel, the green channel and the blue channel to generate the pseudo-color image; and
converting multi-channel visible light reflectance data into 8-bit metadata for each respective channel, and merging the 8-bit metadata according to color attributes to form a true-color visible light image.

8. The method for generating the high-resolution true-color visible light model according to claim 1, wherein the distributed training comprises the following steps:
transmitting the training set, the validation set and the test set to distributed training nodes using a SSH protocol; and
each node performing training and modeling using an adversarial neural network pix2pixHD to generate the true-color visible light band reflectance model.

9. A method for inferring a high-resolution true-color visible light model, comprising the method for generating the high-resolution true-color visible light model according to claim 1, wherein the method comprises:
inferring the true-color visible light band reflectance model to obtain a local area true-color visible light reflectance tile matrix at the original resolution;
replacing pixel values within the clear-sky area with color values corresponding to the surface reflectance in the corresponding area to generate a local area true-color visible light reflectance tile;
merging the local area true-color visible light reflectance tiles according to geographical regions to form a true-color visible light cloud image, with a spatial resolution of no less than 4 kilometers; and
for overlapping parts of the local area during the merging process, applying smoothing processing.

10. A system for generating and inferring high-resolution true-color visible light intensity, wherein the method for inferring the high-resolution true-color visible light model according to claim 9, wherein the system for generating and inferring the high-resolution true-color visible light intensity comprises:
a data acquisition device, configured to obtain satellite meteorological data at the original resolution;
a data preprocessing device, configured to extract historical infrared data and brightness temperature data from multi-channel satellite observation data from the satellite meteorological data, and to form a standard distribution model of historical infrared brightness temperature at the original resolution and a full-disk two-dimensional brightness temperature model, respectively;
a clear-sky mask processing device, configured to compare the similarity between the standard distribution model of historical infrared brightness temperature at the original resolution and the full-disk two-dimensional brightness temperature model for the same time period and region, identify a clear-sky area, and form a clear-sky mask within the clear-sky area; and after removing a clear-sky signal, generate a historical multi-channel cloud satellite dataset;
a data learning device, configured to perform distributed training on the historical multi-channel cloud satellite dataset at each node and form a true-color visible light band reflectance model at the original resolution; and
a data inference device, configured to invert the true-color visible light band reflectance model to obtain a local true-color visible light reflectance tile matrix; and merge the local true-color visible light reflectance tile matrix according to geographical regions to form a true-color visible light cloud image, and apply smoothing processing to overlapping areas.
